(19) United States
(12) Patent Application Publication
(10) Pub. No.: US 2013/0121627 A1
(43) Pub. Date: May 16, 2013

(54) HYDRODYNAMIC BEARING ASSEMBLY AND SPINDLE MOTOR INCLUDING THE SAME

(71) Applicant: SAMSUNG ELECTRO-MECHANICS CO., LTD., Suwon (KR)

(72) Inventor: Chang Keun JUN, Suwon (KR)

(73) Assignee: SAMSUNG ELECTRO-MECHANICS CO., LTD., Suwon (KR)

(21) Appl. No.: 13/652,816

(22) Filed: Oct. 16, 2012

(30) Foreign Application Priority Data
Nov. 10, 2011 (KR) 10-2011-0116975

(51) Int. Cl. H02K 7/08

(52) U.S. Cl. CPC H02K 7/08
USPC 384/115; 384/100; 384/123

(57) ABSTRACT

The hydrodynamic bearing assembly includes: a sintered sleeve having a shaft hole formed therein such that a shaft is rotatably inserted thereinto and including at least one dynamic pressure bearing part to generate dynamic pressure in a lubricating fluid filled in a bearing clearance at the time of rotation of the shaft; and a housing provided to enclose an outer peripheral surface of the sintered sleeve, wherein a bottom surface of a dynamic pressure groove of the at least one dynamic pressure bearing part has a porosity higher than that of a protrusion surface thereof.

### CROSS-REFERENCE TO RELATED APPLICATIONS

This application claims the priority of Korean Patent Application No. 10-2011-0116975 filed on Nov. 10, 2011, in the Korean Intellectual Property Office, the disclosure of which is incorporated herein by reference.

### BACKGROUND OF THE INVENTION

1. Field of the Invention

The present invention relates to a hydrodynamic bearing assembly and a spindle motor including the same.

2. Description of the Related Art

A hard disk drive (HDD), an information storage device, reads data stored on a disk or writes data to the disk using a read/write head.

The hard disk drive requires a disk driving device capable of driving the disk. As the disk driving device, a small-sized motor is used.

In the small-sized motor, a hydrodynamic bearing assembly is commonly used. A shaft, a rotating member of the hydrodynamic bearing assembly, and a sleeve, a fixed member thereof, include oil interposed therebetween, such that the shaft is supported by fluid pressure generated in the oil.

Here, as the sleeve used in the small-sized motor, there may be provided a sintered sleeve or a processed sleeve. In order to make a price of the motor more competitive, a sintered sleeve having a large amount of oil has mainly been used.

However, when the sintered sleeve is used, it may have an excessive amount of oil, such that a variation in an oil interface is increased due to the thermal expansion of the oil. In addition, the sintered sleeve requires a sleeve housing enclosing an outer diameter of the sleeve in order to prevent the leakage of oil.

In the hydrodynamic bearing assembly using this sintered sleeve, since a number of pores are present in an inner peripheral surface of the sintered sleeve, a large amount of oil in a bearing clearance formed between the shaft and the sleeve may be absorbed at the time of an operation of the motor, such that a journal bearing may not be effectively formed.

Therefore, a method of improving bearing rigidity, even in the case of a sintered sleeve being used, has been demanded.

### SUMMARY OF THE INVENTION

An aspect of the present invention provides a spindle motor having improved bearing rigidity even in the case of a sintered sleeve being used therein.

According to an aspect of the present invention, there is provided a hydrodynamic bearing assembly including: a sintered sleeve having a shaft hole formed therein such that a shaft is rotatably inserted thereinto and including at least one dynamic pressure bearing part to generate dynamic pressure in a lubricating fluid filled in a bearing clearance at the time of rotation of the shaft; and a housing provided to enclose an outer peripheral surface of the sintered sleeve, wherein a bottom surface of a dynamic pressure groove of the at least one dynamic pressure bearing part has a porosity higher than that of a protrusion surface thereof.

The dynamic pressure groove may be a radial dynamic pressure groove formed in an inner peripheral surface of the sintered sleeve.

The dynamic pressure groove may be a thrust dynamic pressure groove formed in an upper or lower surface of the sintered sleeve in an axial direction.

The at least one dynamic pressure bearing part may include the dynamic pressure groove having any one of a herringbone shape, a spiral shape, and a screw shape.

The dynamic pressure groove of the at least one dynamic pressure bearing part may be formed by an electrolytic machining method.

According to another aspect of the present invention, there is provided a spindle motor including the hydrodynamic bearing assembly as described above.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to a first embodiment of the present invention;

FIG. 2 is a schematic cross-sectional view showing a dynamic pressure bearing assembly according to the first embodiment of the present invention;

FIGS. 3A and 3B are schematic cross-sectional views of a sleeve according to first and second embodiments of the present invention, FIG. 3A is a cross-sectional view showing a shape of a radial dynamic pressure bearing part, and FIG. 3B is a plan view showing a shape of a thrust dynamic pressure bearing part;

FIG. 4 is a schematic cross-sectional view showing a spindle motor according to the second embodiment of the present invention;

FIG. 5 is a schematic cross-sectional view showing a dynamic pressure bearing assembly according to the second embodiment of the present invention;

FIG. 6A is a schematic cross-sectional view showing a recording disk driving device in which the spindle motor according to the first embodiment of the present invention is mounted; and

FIG. 6B is a schematic cross-sectional view showing a recording disk driving device in which the spindle motor according to the second embodiment of the present invention is mounted.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, like reference numerals will be used to designate like components having similar functions throughout the drawings within the scope of the present invention.

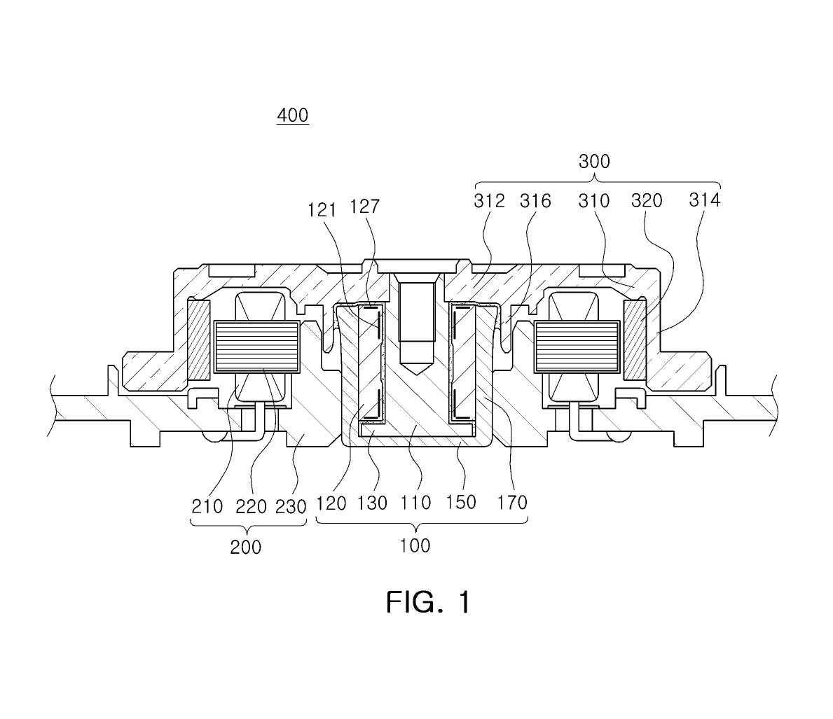

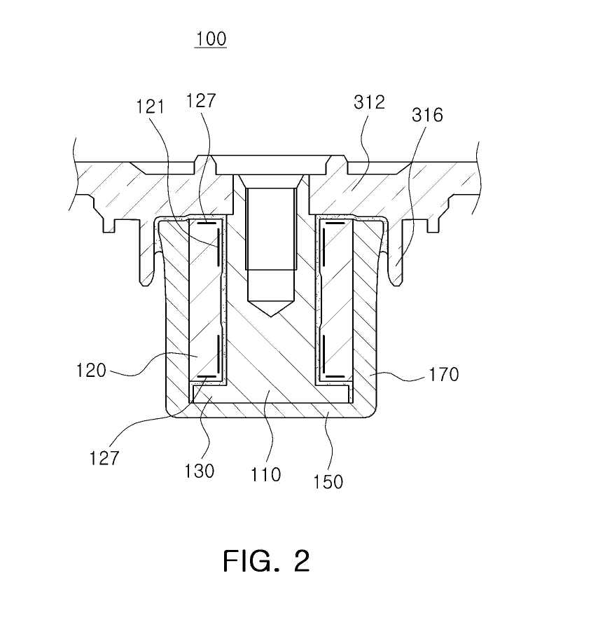

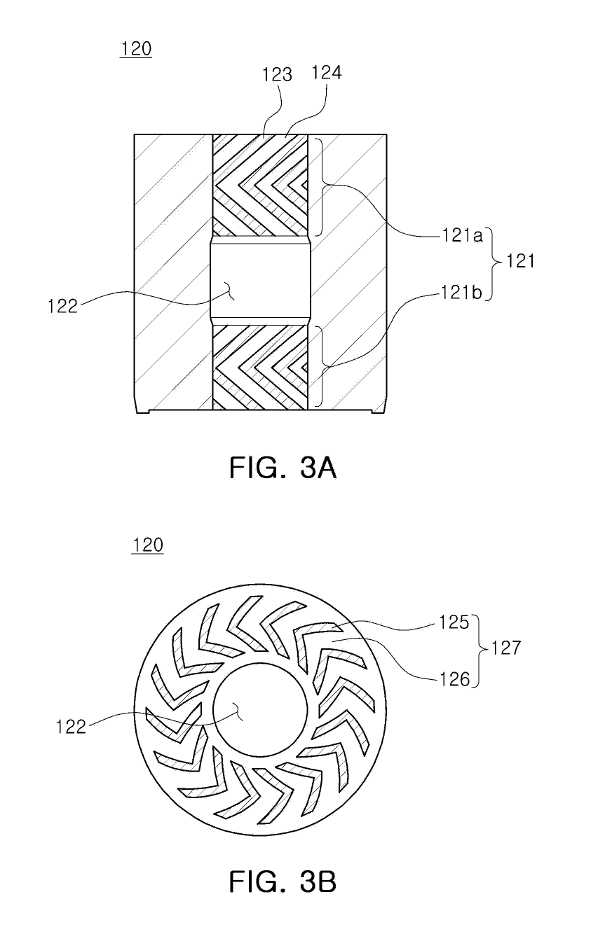

FIG. 1 is a schematic cross-sectional view showing a spindle motor according to a first embodiment of the present invention. FIG. 2 is a schematic cross-sectional view showing a dynamic pressure bearing assembly according to the first embodiment of the present invention. FIGS. 3A and 3B are schematic cross-sectional views of a sleeve according to first and second embodiments of the present invention, FIG. 3A is a cross-sectional view showing a shape of a radial dynamic pressure bearing part, and FIG. 3B is a plan view showing a shape of a thrust dynamic pressure bearing part.

Referring to FIGS. 1 through 3, a spindle motor 400 according to the first embodiment of the present invention may include a hydrodynamic bearing assembly 100, a stator 200, and a rotor 300.

The hydrodynamic bearing assembly 100 may include a shaft 110, a sleeve 120, a thrust plate 130, a cover member 140, and a housing 170.

Here, terms with respect to directions will be first defined. As viewed in FIGS. 1 and 2, an axial direction refers to a vertical direction based on the shaft 110 and an outer diameter direction or an inner diameter direction refers to a direction toward an outer edge of the rotor 300 based on the shaft 110 or a direction toward the center of the shaft 110 based on the outer edge of the rotor 300.

The sleeve 120 may support the shaft 110 such that an upper end of the shaft 110 protrudes upwardly in the axial direction. The sleeve 120 may be formed by sintering a Cu—Fe-based alloy powder or a steel use stainless (SUS)-based powder.

Here, the shaft 110 may be inserted into a shaft hole 122 of the sleeve 120 such that the shaft 110 and the sleeve 120 have a micro clearance therebetween. The micro clearance maybe filled with a lubricating fluid, and the rotation of the rotor 300 may be more smoothly supported by a radial dynamic pressure bearing part 121 formed in at least one of an outer diameter of the shaft 110 and an inner diameter of the sleeve 120, the radial dynamic pressure bearing part 121 including a radial dynamic pressure groove 123 and a protrusion part 124.

The radial dynamic pressure groove 123 may be formed in an inner surface of the sleeve 120, which is an inner portion of the shaft hole 122 of the sleeve 120, and may form pressure such that the shaft 110 and the sleeve 120 are spaced apart from each other by a predetermined distance at the time of rotation of the shaft 110.

However, the radial dynamic pressure groove 123 is not limited to being formed in the inner surface of the sleeve 120 as described above but may also be formed in an outer peripheral surface of the shaft 110. In addition, the number of radial dynamic pressure grooves 123 is not limited.

Meanwhile, in the case in which the radial dynamic pressure groove 123 is formed in the inner surface of the sleeve 120, a bottom surface of the radial dynamic pressure groove 123 may have a porosity higher than that of an upper surface of the protrusion part 124.

More specifically, the bottom surface of the radial dynamic pressure groove 123 may have a porosity of about 10 to 40%, and the upper surface of the protrusion part 124 may have a porosity of 10% or less.

When the upper surface of the protrusion part 124 has a low porosity, dynamic pressure may be easily generated to facilitate floating of the shaft and increase bearing rigidity, while when the bottom surface of the radial dynamic pressure groove 123 has a high porosity, circulation of the lubricating fluid, that is, a process in which the lubricating fluid is absorbed in and expelled from the sleeve 120 may be facilitated, such that unique characteristics of a sintered sleeve may be used.

Here, the radial dynamic pressure groove 123 may have any one of a herringbone shape, a spiral shape, and a screw shape.

In addition, the radial dynamic pressure bearing part 121 may include at least two dynamic pressure bearing parts, that is, an upper dynamic pressure bearing part 121a and a lower dynamic pressure bearing part 121b, but is not limited thereto.

The sleeve 120 may include a bypass channel (not shown) formed therein to allow upper and lower portions thereof to be in communication with each other, such that pressure of the lubricating fluid in the hydrodynamic bearing assembly 100 may be dispersed, thereby allowing balance in the pressure of the lubricating fluid to be maintained, and air bubbles, or the like, present in the hydrodynamic bearing assembly 100 may be moved to be discharged through circulation.

Here, the sleeve 120 may be inserted into the housing 170 to be described below, and a cover member 150 to be described below may be coupled to a lower portion of the housing 170 in the axial direction, while having a clearance maintained between the shaft 110 and the cover member 150. Here, the clearance may receive the lubricating fluid therein.

The cover member 150 may receive the lubricating fluid in the clearance between the cover member 150 and the shaft 110 or the thrust plate 130 to thereby serve as a bearing supporting a lower surface of the shaft 110.

The thrust plate 130 may be disposed on the lower portion of the sleeve 120 and have the shaft 110 insertedly fixed to a hole formed in the center thereof.

Here, the thrust plate 130 may be separately manufactured and then coupled to the shaft 110. However, the thrust plate 130 may be formed integrally with the shaft 110 at the time of manufacturing thereof and may rotate together with the shaft 110 at the time of the rotation of the shaft 110.

In addition, the thrust plate 130 may include a thrust dynamic pressure bearing part 127 formed in an upper surface or a lower surface thereof, the thrust dynamic pressure bearing part 127 providing thrust dynamic pressure to the shaft 110.

The thrust dynamic pressure bearing part 127 is not limited to being formed in the upper surface or the lower surface of the thrust plate 130 as described above but may also be formed in a lower surface of the sleeve 120 corresponding to the upper surface of the thrust plate 130 or an upper surface of the cover member 150 corresponding to the lower surface of the thrust plate 130.

Here, in the case in which the thrust dynamic pressure bearing part 127 is formed in the upper or lower surface of the sleeve 120 in the axial direction, a bottom surface of a thrust dynamic pressure groove 125 forming the thrust dynamic pressure bearing part 127 may have a porosity higher than that of an upper surface of a protrusion part 126.

More specifically, the bottom surface of the thrust dynamic pressure groove 125 may have a porosity of about 10 to 40%, and the upper portion of the protrusion part 126 may have a porosity of 10% or less.

When the upper surface of the protrusion part 126 has a low porosity, dynamic pressure may be easily generated to facilitate floating of the shaft and increase bearing rigidity, while when the bottom surface of the thrust dynamic pressure groove 125 has a high porosity, circulation of the lubricating fluid, that is, a process in which the lubricating fluid is absorbed in and expelled from the sleeve 120 may be facilitated, such that unique characteristics of the sintered sleeve may be used.

Here, the thrust dynamic pressure groove 125 may have any one of a herringbone shape, a spiral shape, and a screw shape.

The housing 170 provided to enclose the sleeve 120 may be coupled to an outer peripheral surface of the sleeve 120. More specifically, the sleeve 120 may be inserted into an inner peripheral surface of the housing 170 and coupled to the housing 170 by press-fitting or bonding.

Here, the housing 170 may be a portion of a base member 230 configuring the stator 200 to be described below. However, in order to describe a coupling relationship between the sleeve 120 and the housing 170, the housing 170 will be regarded as a component configuring the hydrodynamic bearing assembly 100.

The housing 170 may be coupled to the outer peripheral surface of the sleeve 120 containing oil to thereby prevent the leakage of the oil.

In addition, the housing 170 may include the cover member 150 coupled to the lower portion thereof while having the clearance maintained between the thrust plate 130 and the cover member 150. The clearance may receive the lubricating fluid therein.

The cover member 150 may receive the lubricating fluid in the clearance between the cover member 150 and the shaft 110 or the thrust plate 130 to thereby serve as a bearing supporting the lower surface of the shaft 110.

Here, the cover member 150 may be manufactured as a separate member and then coupled to the housing 170 by press-fitting or an adhesive. In addition, the cover member 150 may be formed integrally with the housing 170 and be manufactured by various methods such as a pressing method, a casting method, or the like.

Further, according to the embodiment of the present invention, an inner peripheral surface of a main wall part 316 included in a rotor case 310 and an outer peripheral surface of the housing 170 may include a sealing part provided therebetween, the sealing part having an oil interface formed therein. Therefore, the outer peripheral surface of the housing 170 may be tapered in the inner diameter direction, downwardly in the axial direction, in order that a capillary phenomenon may be appropriately generated.

The rotor 300, a rotational structure rotatably provided with respect to the stator 200, may include the rotor case 310 having an annular ring shaped magnet 320 provided on an outer peripheral surface thereof, the annular ring shaped magnet 320 corresponding to the core 220 while having a predetermined interval therebetween.

In addition, as the magnet 320, a permanent magnet generating magnetic force having a predetermined strength by alternately magnetizing an N pole and an S pole thereof in a circumferential direction is used.

Here, the rotor case 310 may include a hub base 312 press-fitted into the upper end of the shaft 110 to be fixed thereto and a magnet support part 314 extended from the hub base 312 in the outer diameter direction and bent downwardly in the axial direction to thereby support the magnet 320 of the rotor 300.

In addition, the rotor case 310 may include the main wall part 316 extended downwardly in the axial direction so that the sealing part sealing the lubricating fluid is provided between the main wall part 316 and the housing 170.

The outer peripheral surface of the housing 170 may be tapered in the inner diameter direction, downwardly in the axial direction so that an interval between the main wall part 316 and the housing 170 is widened downwardly in the axial direction in order to prevent the leakage of the lubricating fluid to the outside at the time of the driving of the spindle motor.

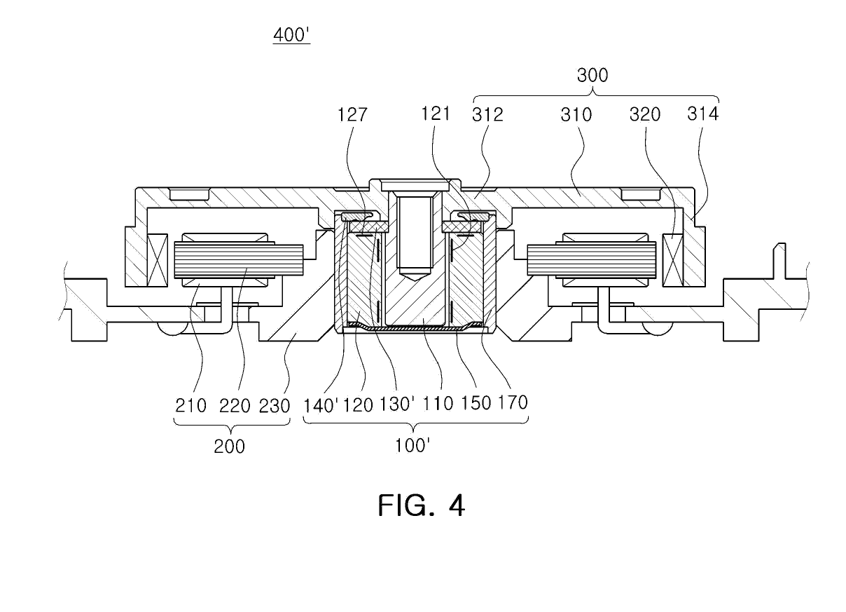

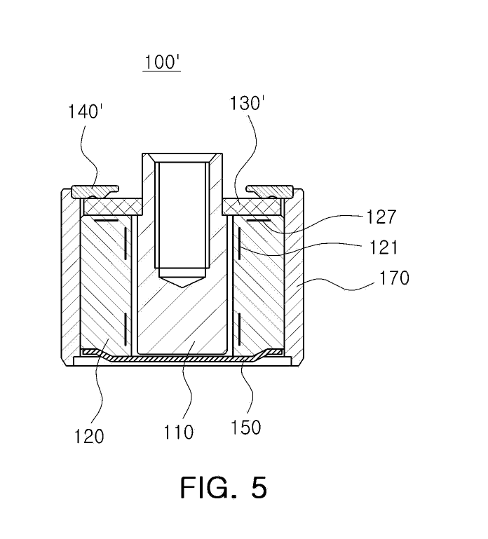

FIG. 4 is a schematic cross-sectional view showing a spindle motor according to the second embodiment of the present invention. FIG. 5 is a schematic cross-sectional view showing a dynamic pressure bearing assembly according to the second embodiment of the present invention.

Referring to FIGS. 3 and 5, a spindle motor 400′ according to the second embodiment of the present invention may include a hydrodynamic bearing assembly 100′, the stator 200, and the rotor 300. The spindle motor 400′ according to the second embodiment of the present invention is different from the spindle motor 400 according to the first embodiment of the present invention in terms of the hydrodynamic bearing assembly 100′. More specifically, the spindle motor 400′ according to the second embodiment of the present invention is different from the spindle motor 400 according to the first embodiment of the present invention in that a thrust plate (denoted by reference numeral 130′) is formed on an upper portion of the shaft 110.

Therefore, the hydrodynamic bearing assembly 100′ will be described in detail. Meanwhile, since configurations of the stator 200 and the rotor 300 in the spindle motor 400′ according to the second embodiment of the present invention are the same as those of the spindle motor 400 according to the first embodiment of the present invention, a detailed description thereof will be omitted. In addition, the same reference numerals will be used to describe the same components.

The hydrodynamic bearing assembly 100′ according to the second embodiment of the present invention may include the shaft 110, the sleeve 120, a thrust plate 130′, a cap member 140′, the cover member 150, and the housing 170.

Here, terms with respect to directions will be first defined. As viewed in FIGS. 4 and 5, an axial direction refers to a vertical direction based on the shaft 110 and an outer diameter direction or an inner diameter direction refers to a direction toward an outer edge of the rotor 300 based on the shaft 110 or a direction toward the center of the shaft 110 based on the outer edge of the rotor 300.

The sleeve 120 may support the shaft 110 such that the upper end of the shaft 110 protrudes upwardly in the axial direction. The sleeve 120 may be formed by sintering a Cu—Fe-based alloy powder or a SUS-based powder.

Here, the shaft 110 may be inserted into the shaft hole 122 of the sleeve 120 such that the shaft 110 and the sleeve 120 have the micro clearance therebetween. The micro clearance may be filled with a lubricating fluid, and the rotation of the rotor 300 may be more smoothly supported by the radial dynamic pressure bearing part 121 formed in at least one of the outer diameter of the shaft 110 and the inner diameter of the sleeve 120, the radial dynamic pressure bearing part 121 including the radial dynamic pressure groove 123 and the protrusion part 124.

The radial dynamic pressure groove 123 may be formed in the inner surface of the sleeve 120, which is an inner portion of the shaft hole 122 of the sleeve 120, and may form pressure such that the shaft 110 and the sleeve 120 are spaced apart from each other by a predetermined distance at the time of rotation of the shaft 110.

However, the radial dynamic pressure groove 123 is not limited to being formed in the inner surface of the sleeve 120 as described above but may also be formed in the outer peripheral surface of the shaft 110. In addition, the number of radial dynamic pressure grooves 123 is not limited.

Meanwhile, in the case in which the radial dynamic pressure groove 123 is formed in the inner surface of the sleeve 120, the bottom surface of the radial dynamic pressure groove 123 may have a porosity higher than that of the upper surface of the protrusion part 124.

More specifically, the bottom surface of the radial dynamic pressure groove 123 may have a porosity of about 10 to 40%, and the upper surface of the protrusion part 124 may have a porosity of 10% or less.

When the upper surface of the protrusion part 124 has a low porosity, dynamic pressure may be easily generated to facilitate floating of the shaft and increase bearing rigidity, while when the bottom surface of the radial dynamic pressure groove 123 has a high porosity, circulation of the lubricating fluid, that is, a process in which the lubricating fluid is absorbed in and expelled from the sleeve 120 may be facilitated, such that unique characteristics of a sintered sleeve may be used.

Here, the radial dynamic pressure groove 123 may have any one of a herringbone shape, a spiral shape, and a screw shape.

In addition, the radial dynamic pressure bearing part 121 may include at least two dynamic pressure bearing parts, that is, the upper dynamic pressure bearing part 121a and the lower dynamic pressure bearing part 121b, but is not limited thereto.

The sleeve 120 may include a bypass channel (not shown) formed therein to allow the upper and lower portions thereof to be in communication with each other, such that pressure of the lubricating fluid in the hydrodynamic bearing assembly 100′ may be dispersed, thereby allowing balance in the pressure of the lubricating fluid to be maintained, and air bubbles, or the like, present in the hydrodynamic bearing assembly 100′ may be moved to be discharged through circulation.

Here, the sleeve 120 may be inserted into the housing 170 to be described below, and the cover member 150 to be described below may be coupled to the lower portion of the housing 170 in the axial direction, while having the clearance maintained between the shaft 110 and the cover member 150. Here, the clearance may receive the lubricating fluid therein.

The cover member 150 may receive the lubricating fluid in the clearance between the cover member 150 and the shaft 110 or the thrust plate 130′ to thereby serve as a bearing supporting the lower surface of the shaft 110.

The thrust plate 130′ may be disposed on the upper portion of the sleeve 120 and have the shaft 110 insertedly fixed to a hole formed in the center thereof.

Here, the thrust plate 130′ may be separately manufactured and then coupled to the shaft 110. However, the thrust plate 130′ may be formed integrally with the shaft 110 at the time of manufacturing thereof and may rotate together with the shaft 110 at the time of the rotation of the shaft 110.

In addition, the thrust plate 130′ may include the thrust dynamic pressure bearing part 127 formed in an upper surface or a lower surface thereof, the thrust dynamic pressure bearing part 127 providing thrust dynamic pressure to the shaft 110.

The thrust dynamic pressure bearing part 127 is not limited to being formed in the upper surface or the lower surface of the thrust plate 130′ as described above but may also be formed in the upper surface of the sleeve 120 corresponding to the lower surface of the thrust plate 130′ or a lower surface of the cap member 140′ corresponding to the upper surface of the thrust plate 130′.

Here, in the case in which the thrust dynamic pressure bearing part 127 is formed in the upper or lower surface of the sleeve 120 in the axial direction, the bottom surface of the thrust dynamic pressure groove 125 forming the thrust dynamic pressure bearing part 127 may have a porosity higher than that of the upper surface of the protrusion part 126.

More specifically, the bottom surface of the thrust dynamic pressure groove 125 may have a porosity of about 10 to 40%, and the upper portion of the protrusion part 126 may have a porosity of 10% or less.

When the upper surface of the protrusion part 126 has a low porosity, dynamic pressure may be easily generated to facilitate floating of the shaft and increase bearing rigidity, while when the bottom surface of the thrust dynamic pressure groove 125 has a high porosity, circulation of the lubricating fluid, that is, a process in which the lubricating fluid is absorbed in and expelled from the sleeve 120 may be facilitated, such that unique characteristics of a sintered sleeve may be used.

Here, the thrust dynamic pressure groove 125 may have any one of a herringbone shape, a spiral shape, and a screw shape.

The housing 170 provided to enclose the sleeve 120 may be coupled to the outer peripheral surface of the sleeve 120. More specifically, the sleeve 120 may be inserted into the inner peripheral surface of the housing 170 and coupled to the housing 170 by press-fitting or bonding.

Here, the housing 170 may be a portion of the base member 230 configuring the stator 200 to be described below. However, in order to describe a coupling relationship between the sleeve 120 and the housing 170, the housing 170 will be regarded as a component configuring the hydrodynamic bearing assembly 100′.

The housing 170 may be coupled to the outer peripheral surface of the sleeve 120 containing oil to thereby prevent the leakage of the oil.

In addition, the housing 170 may include the cover member 150 coupled to the lower portion thereof while having the clearance maintained between the shaft 110 and the cover member 150. The clearance may receive the lubricating fluid therein.

The cover member 150 may receive the lubricating fluid in the clearance between the cover member 150 and the shaft 110 to thereby serve as a bearing supporting the lower surface of the shaft 110.

Here, the cover member 150 may be manufactured as a separate member and then coupled to the housing 170 by press-fitting or an adhesive. In addition, the cover member 150 may be formed integrally with the housing 170 and be manufactured by various methods such as a pressing method, a casting method, or the like.

Further, according to the embodiment of the present invention, the lower surface of the cap member 140′ coupled to an upper portion of the housing 170 and the upper surface of the thrust plate 130′ may include a sealing part provided therebetween, the sealing part having an oil interface formed therein. Therefore, the lower surface of the cap member 140′ may be tapered in the inner diameter direction in order that a capillary phenomenon may be appropriately generated.

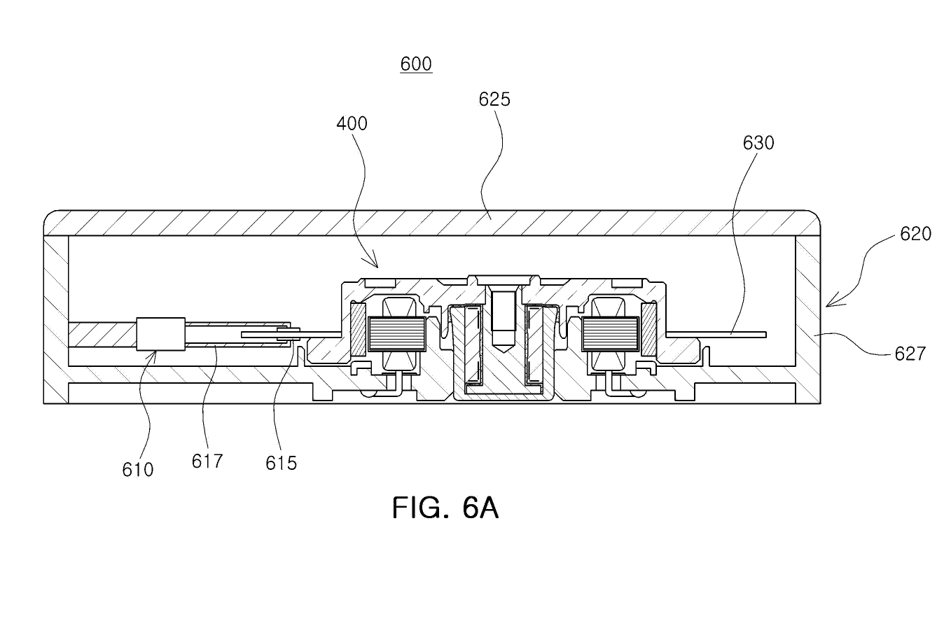

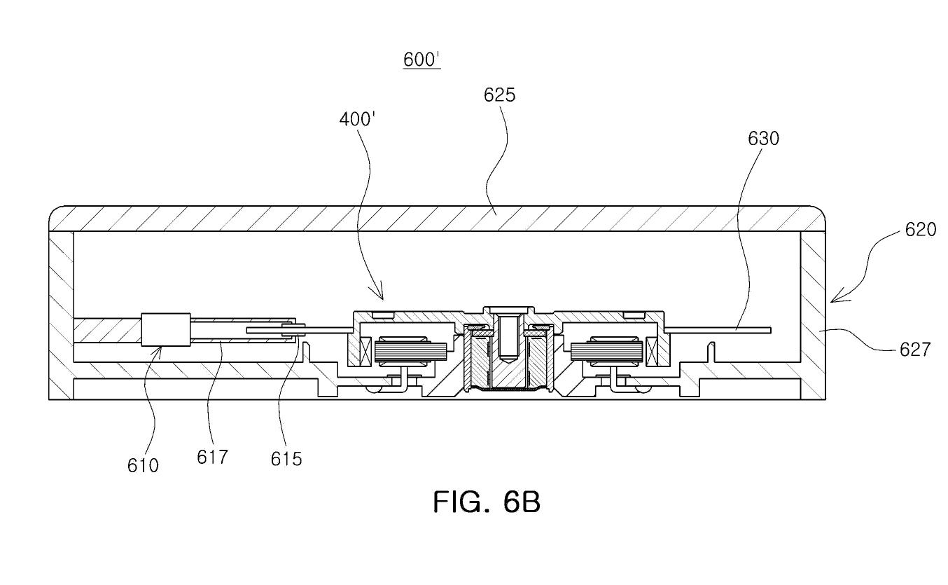

FIG. 6A and FIG. 6B are schematic cross-sectional views showing recording disk driving devices in which the spindle motor according to the first and the second embodiments of the present invention are mounted.

Referring to FIGS.6A and 6B, recording disk driving device 600 and 600′ including the spindle motor 400 or 400′ according to the embodiment of the present invention mounted therein may be a hard disk driving device and include the spindle motor 400 or 400′, a head transfer part 610, and a housing 620.

The spindle motor 400 or 400′ has all the characteristics of the spindle motor according to the embodiment of the present invention described above and may have a recording disk 630 mounted thereon.

The head transfer part 610 may transfer a head 615 detecting information of the recording disk 630 mounted on the spindle motor 400 or 400′ to a surface of the recording disk of which information is to be detected.

In this case, the head 615 may be disposed on a support member 617 of the head transfer part 610.

The housing 620 may include a motor mounting plate 627 and a top cover 625 shielding an upper portion of the motor mounting plate 627 in order to form an inner space receiving the spindle motor 400 or 400′ and the head transfer part 610.

As described above, in the hydrodynamic bearing assemblies 100 and 100′ and the spindle motors 400 and 400′ including the same according to the embodiments of the present invention, since the dynamic pressure groove and the protrusion part of the dynamic pressure bearing part may have different porosities, bearing rigidity may be improved even in a sintered sleeve to thereby provide a stable product.

As set forth above, with the hydrodynamic bearing assembly and the spindle motor including the same according to the embodiment of the present invention, bearing rigidity can be improved even in the case of using a sintered sleeve.

In addition, since the groove of the dynamic pressure bearing part is formed in a simple scheme and the groove and the protrusion part can have different porosities, the hydrodynamic bearing assembly may be very easily applied to a product.

While the present invention has been shown and described in connection with the embodiments, it will be apparent to those skilled in the art that modifications and variations can be made without departing from the spirit and scope of the invention as defined by the appended claims.

What is claimed is:

1. A hydrodynamic bearing assembly comprising:
a sintered sleeve having a shaft hole formed therein such that a shaft is rotatably inserted thereinto and including at least one dynamic pressure bearing part to generate dynamic pressure in a lubricating fluid filled in a bearing clearance at the time of rotation of the shaft; and
a housing provided to enclose an outer peripheral surface of the sintered sleeve,
wherein a bottom surface of a dynamic pressure groove of the at least one dynamic pressure bearing part has a porosity higher than that of a protrusion surface thereof.

2. The hydrodynamic bearing assembly of claim 1, wherein the dynamic pressure groove is a radial dynamic pressure groove formed in an inner peripheral surface of the sintered sleeve.

3. The hydrodynamic bearing assembly of claim 1, wherein the dynamic pressure groove is a thrust dynamic pressure groove formed in an upper or lower surface of the sintered sleeve in an axial direction.

4. The hydrodynamic bearing assembly of claim 1, wherein the at least one dynamic pressure bearing part includes the dynamic pressure groove having any one of a herringbone shape, a spiral shape, and a screw shape.

5. The hydrodynamic bearing assembly of claim 1, wherein the dynamic pressure groove of the at least one dynamic pressure bearing part is formed by an electrolytic machining method.

6. A spindle motor comprising the hydrodynamic bearing assembly of claim 1.
